(19) United States
(12) Patent Application Publication
(10) Pub. No.: US 2025/0269595 A1
(43) Pub. Date: Aug. 28, 2025

(54) PRINT BED ASSEMBLY FOR AN ADDITIVE MANUFACTURING SYSTEM

(71) Applicant: Ultimaker B.V., Utrecht (NL)

(72) Inventors: Jirí Konvicný, Utrecht (NL); Arend-Jan Van Lent, Utrecht (NL)

(73) Assignee: Ultimaker B.V., Utrecht (NL)

(21) Appl. No.: 18/858,377

(22) PCT Filed: Apr. 5, 2023
(86) PCT No.: PCT/NL2023/050176

§ 371 Date: Oct. 21, 2024

(30) Foreign Application Priority Data
Apr. 28, 2022 (NL) 2031725

(51) Int. Cl. B29C 64/245; B29C 64/295; B33Y 30/00

(52) U.S. Cl. CPC B29C 64/245; B29C 64/295; B33Y 30/00

(57) ABSTRACT

A print bed assembly (200) for an additive manufacturing system (100) comprises a stage (202), a carrier plate (204) extending in a first direction (A1), a build plate (220) removably arranged on the carrier plate, and at least one rear clip (222) that detachably couples the build plate (220) with the carrier plate. The print bed assembly comprises a slide body (228) and at least one front clip (240) arranged to detachably couple the build plate with the carrier plate. In an embodiment, the print bed assembly comprises at least one handle (246) and at least one push element (250) arranged to move the build plate relative to the carrier plate in the first direction.

### FIELD OF THE INVENTION

The present invention relates to a print bed assembly for an additive manufacturing system. The invention also relates to an additive manufacturing system comprising such a print bed assembly.

### BACKGROUND ART

Fused filament fabrication (FFF) is an additive manufacturing process that typically uses a continuous filament of a thermoplastic material. The filament may be fed from a filament supply unit to a moving, heated print head, and may be deposited through a print nozzle onto an upper surface of a build plate. Further, the print head may be moved relative to the build plate under control to manufacture a work product that may comprise multiple deposited layers. In some cases, it may also be required to move the work product vertically by a small amount to begin a new layer. In this manner, a three-dimensional object may be produced out of the thermoplastic material.

Further, the build plate forms a part of a print bed assembly. The print bed assembly may also comprise a mounting base, such as a stage, and a carrier plate. The print bed assembly may be vertically movable to allow a movement of the work product relative to the print head. The build plate may be a glass plate removably coupled to the carrier plate by one or more coupling means. The coupling means may comprise, for example, one or more metal front clips and one or more metal rear clips that may hold the build plate within the print bed assembly. Some conventional coupling means may also comprise magnetic coupling and vacuum-based coupling, which are typically complex, costly, and/or unreliable as compared to clip-based coupling.

Conventional front clips and rear clips typically have a small size and shape. Due to their design, the front clips and the rear clips may not allow easy and convenient removal as well as installation of the build plate, thereby affecting usability of the additive manufacturing system. Further, the front and rear clips may be susceptible to failures, such as due to deformation, due to a pulling force applied by a user during the removal of the build plate. The failure of the front and/or rear clips may increase a downtime associated with the additive manufacturing system and may also warrant additional repairing costs. Moreover, a current design of the print bed assembly may be such that users may not be able to conveniently and firmly hold the build plate during the removal and/or the installation of the build plate. Thus, such conventional print bed assemblies may lack in user friendliness and reliability and may also reduce an efficiency of the additive manufacturing system.

Patent publication U.S. Pat. No. 10,703,044 B2 describes a 3D printer including a build platform and a build plate that is structured for being removably clamped to the build platform. The build platform includes a base, a heating layer, at least one compressible biasing element arranged between the base and a heating layer, and a clamp, and where the build platform is configured for receiving the build plate into a clamping position in which the clamp is configured to releasably clamp the build plate onto the build platform.

### SUMMARY OF THE INVENTION

The aim of the present invention is to provide a new and improved print bed assembly for an additive manufacturing system. The print bed assembly may comprise multiple components that may support a work product being formed by the additive manufacturing system.

According to a first aspect of the present invention, there is provided a print bed assembly for an additive manufacturing system, the print bed assembly comprising a stage and a carrier plate coupled to and spaced apart from the stage. The carrier plate extends in a first direction from a rear side of the carrier plate to a front side of the carrier plate, and extends in a second direction which is perpendicular to the first direction. The assembly also comprises a build plate removably arranged on the carrier plate, and at least one rear clip arranged to detachably couple the build plate with the carrier plate at the rear side of the carrier plate, wherein the at least one rear clip is arranged to clamp the build plate onto the carrier plate using a first clamping force.

The assembly also comprises a slide body slidably arranged between the stage and the carrier plate. At least one front clip is arranged to detachably couple the build plate with the carrier plate at the front side of the carrier plate, the at least one front clip being coupled to the slide body, wherein the at least one front clip is arranged to clamp the build plate onto the carrier plate using a second clamping force. The assembly comprises at least one handle coupled to the slide body at the front side of the carrier plate.

The assembly further comprises at least one push element coupled at a rear side of the slide body, and arranged to move the build plate relative to the carrier plate in the first direction only after the slide body has been moved by a predefined distance. Upon application of a pulling force on the at least one handle in the first direction, the slide body is moved relative to the carrier plate, wherein first the at least one front clip detaches from the build plate and the carrier plate and then, after the slide body is moved more than the predefined distance, the at least one push element pushes the build plate in the first direction thereby releasing the build plate out of the at least one rear clip.

By providing at least one handle at the front, a user can simply pull the handle after which both the front side and the back side of the build plate becomes detached from the carrier plate and can easily be removed from the assembly and thus out of the additive manufacturing system for further processing of the manufactured object or for cleaning of the build plate. The print bed assembly described herein may be user-friendly and reliable in operation. The print bed assembly may allow easy installation and removal of the build plate from the front clips and the rear clips. The print bed assembly described herein may also increase an efficiency of the additive manufacturing system. Further, a design of the front clips and the rear clips may allow easy disengagement and engagement of the build plate with the front clips and the rear clips. In an example, the at least one handle may have an ergonomic design for improved holding by a user.

In an embodiment, the second clamping force applied by the at least one front clip is less than the first clamping force applied by the at least one rear clip. In this way, it is assured that the frictional forces on the build plate produced by the at least one front clip are lower than the frictional forces of the at least one rear clip, and that as a result the front clip(s) will let loose before the rear clip(s). This will result in a proper disengagement of the build plate from the carrier plate. It is noted that if the front clip(s) produce too high clamping forces, the build plate could already be pulled in the first direction due to frictional forces by the front clip(s) on the top surface of the build plate. Next, after further pulling at the handle(s), the rear clip(s) will become disengaged due to the at least one push element pushing the build plate out of the rear clip(s), but there is a risk that the build plate is still, at least partly, hold by the front clips. This will lead to a suboptimal removal of the build plate from the carrier plate.

In an embodiment, the carrier plate of the print bed assembly comprises at least one cut-out disposed at the rear side and aligned with the at least one push element. Further, after the slide body is moved by at least the predefined distance, the at least one cut-out at least partially receives the at least one push element therein. As the at least one cut-out may receive the at least one push element therein and allow some travel of the at least one push element in the first direction, the build plate may move by a sufficient distance in the first direction, thereby allowing easy removal of the build plate.

In an embodiment, the at least one cut-out has a cut-out length and the at least one push element is arranged to move the build plate by a maximum distance in the first direction such that the maximum distance is equal to the cut-out length of the at least one cut-out. The cut-out length and the maximum distance may be such that the build plate may be conveniently held by the user during the removal and the installation of the build plate.

In an embodiment, the cut-out length of the at least one cut-out is in a range from 10 mm to 15 mm. The cut-out length may be obtained such that the build plate moves sufficiently along the first direction for easy removal and installation of the build plate.

In an embodiment, the print bed assembly further comprises a pair of side guides arranged to couple with each of the carrier plate and the build plate. Each of the pair of side guides has a guide length that is greater than or equal to the maximum distance. The pair of side guides may constrain a movement of the build plate in the second direction and may also centrally align the build plate. Further, during the removal and/or the installation of the build plate, the build plate may be guided by the pair of side guides from both sides such that the build plate may be self-centred.

In an embodiment, each of the pair of side guides extends from the at least one rear clip. In some cases, the pair of side guides and the at least one rear clip may together hold the build plate in an engaged state proximal to the rear side of the carrier plate. In an example, the print bed assembly may omit the side guides.

In an embodiment, upon application of the pulling force, the at least one push element is moved in the first direction from a first position to a second position. In the first position, the at least one push element is spaced apart from the rear side of the carrier plate by at least the predefined distance. In the second position, the at least one push element abuts the build plate. An abutment of the at least one push element with the build plate and a continual movement of the build plate in the first direction may allow the build plate to disengage from the at least one rear clip.

In an embodiment, the at least one push element is integral with the slide body. In such examples, the slide body and at least one push element may be manufactured as a single piece unit.

In an embodiment, the print bed assembly further comprises at least one flexible member coupling the at least one push element with the slide body. The at least one flexible member may be a separate component joined to the slide body by any suitable joining methods. In an embodiment, the at least one push element and the at least one flexible member may be integral with the slide body.

In an embodiment, the print bed assembly comprises at least one further push element coupled to the at least one handle via the slide body. The at least one further push element is spaced apart from the at least one push element in the second direction. The at least one further push element is arranged to engage the at least one rear clip after the slide body is moved in the first direction by a distance greater than the predefined distance, in order to open the at least one rear clip. When the at least one further push element engages with the at least one rear clip, the at least one further push element may cause the at least one rear clip to open. Further, the at least one further push element may hold the at least one rear clip in an open position until the at least one further push element in in contact with the at least one rear clip. Moreover, during the installation of the build plate, the build plate may be moved towards the at least one rear clip until the build plate engages with the at least one rear clip and the build plate snaps back into the engaged state.

According to another aspect of the invention, there is provided a print bed assembly for an additive manufacturing system, the print bed assembly comprising a stage and a carrier plate coupled to and spaced apart from the stage. The carrier plate extends in a first direction from a rear side of the carrier plate to a front side of the carrier plate, and extends in a second direction which is perpendicular to the first direction. The assembly also comprises a build plate removably arranged on the carrier plate, and at least one rear clip arranged to detachably couple the build plate with the carrier plate at the rear side of the carrier plate, wherein the at least one rear clip is arranged to clamp the build plate onto the carrier plate using a first clamping force. The print bed assembly also comprises a slide body slidably arranged between the stage and the carrier plate. At least one front clip is arranged to detachably couple the build plate with the carrier plate at the front side of the carrier plate, the at least one front clip being coupled to the slide body, wherein the at least one front clip is arranged to clamp the build plate onto the carrier plate using a second clamping force. The assembly comprises at least one handle coupled to the slide body at the front side of the carrier plate. The print bed assembly also comprises at least one build plate clip, each build plate clip being coupled to the slide body at a front side of the carrier plate, and being arranged to clamp the build plate at the front side. The assembly also comprises at least one blocking element arranged at the front side of the carrier plate, the blocking element comprising an abutment for limiting a movement of the build plate relative to the carrier plate in the first direction, wherein a clamping force applied by the at least one build plate clip is more than the clamping force applied by the at least one rear clip. Upon application of the pulling force on the at least one handle, the slide body is moved relative to the carrier plate, wherein first the at least one front clip and the at least one rear clip detach from the build plate and the carrier plate and then, after the build plate has been moved up to the abutment, the build plate clips will let go of the build plate if the at least one handle is pulled further in the first direction. Preferably, the clamping force of the build plate clip(s), is such that it creates a frictional force between the build plate clip(s) and the build plate which overcomes all frictional forces created by the rear clip(s) and the front clip(s). This will result in a controlled movement of the build plate in the first direction when a user pulls at the handle(s).

In an embodiment, each of the at least one handle is connected to one front clip and one build plate clip. The one front clip and the one build plate clip may share a common clamp element. The common clamp element may cooperate with two separate opposing clamp elements.

In an embodiment, the carrier plate comprises cut-outs at a front side for receiving at least part of one of the build plate clips.

In an embodiment, the abutment is spaced apart from a front side of the build plate over a predefined distance in an engaged state of the assembly where the build plate is still clamped by the at least one rear clip.

The print bed assemblies described above may further comprise at least one guiding member at least partially arranged between the stage and the carrier plate. The slide body may be guided by the at least one guiding member during movement of the slide body relative to the carrier plate. The at least one guiding member may guide the movement of the slide body in the first direction and may also ensure an alignment of the slide body relative to the carrier plate and the stage.

In an embodiment, the slide body comprises at least one slot therethrough. The at least one guiding member is at least partially and slidably received within the at least one slot of the slide body. The at least one slot may define a movement path of the at least one guiding member and may also restrict any movement of the at least one guiding member beyond a desired distance.

In an embodiment, the at least one rear clip comprises a leaf spring. A design of the rear clip as described herein may reduce a susceptibility to failure of the rear clip, such as, due to plastic deformation. Further, the design of the at least one rear clip may allow easy engagement and disengagement of the build plate therewith.

In an embodiment, the carrier plate is spaced apart from the slide body by a vertical offset in a third direction perpendicular to the first and second directions. The vertical offset between the carrier plate and the slide body lies in a range of 1 mm to 4 mm. The vertical offset may reduce any interference between the slide body and the carrier plate, the heating element, or the stage. Thus, the slide body may freely move in the first direction for the removal of the build plate and in a direction that is opposite to the first direction for the installation of the build plate.

In an embodiment, the print bed assembly further comprises a heating element arranged under or in the carrier plate. The heating element may heat one or more components of the print bed assembly, such as, the carrier plate and the build plate, so as to maintain a temperature of the one or more components of the print bed assembly at a desired temperature level.

According to a third aspect, there is provided an additive manufacturing system comprising a print bed assembly as described above. Due to the specially designed print bed assembly, the additive manufacturing system may exhibit improved usability, reliability, and efficiency. The additive manufacturing system may be an FFF system. However, the invention is not limited to FFF systems. For example, the additive manufacturing system may be pellet extruder printing system, a 3D inkjet printing system, a selective laser sintering (SLS) system, etcetera.

### BRIEF DESCRIPTION OF THE DRAWINGS

These and other aspects of the invention are apparent from and will be elucidated with reference to the embodiments described hereinafter. In the drawings,

FIG. 1 schematically shows a schematic view of an additive manufacturing system according to an embodiment of the present invention;

FIG. 2 schematically shows a perspective view of a print bed assembly for the additive manufacturing system of FIG. 1 according to an embodiment of the present invention, wherein a push element of the print bed assembly is in a first position;

FIG. 3 illustrates a very schematic view of the various main components of the print bed assembly according to an embodiment;

FIG. 4 schematically shows a perspective view of the print bed assembly with a build plate not shown according to an embodiment of the present invention;

FIG. 5 schematically shows an exploded view of the print bed assembly according to an embodiment of the present invention;

FIG. 6 schematically shows a perspective view of the print bed assembly according to an embodiment with the at least one push element in a second position;

FIG. 7 schematically shows a perspective view of the print bed assembly according to an embodiment with the at least one push element in a third position;

FIG. 8 schematically shows a perspective view of a slide body of the print bed assembly, wherein at least one push element is coupled to the slide body by a flexible member according to an embodiment of the present invention;

FIG. 9 schematically shows a perspective view of a part of the print bed assembly comprising the at least one push element and at least one further push element according to an embodiment of the present invention;

FIG. 10 schematically shows a perspective view of a part of the print bed assembly according to an embodiment having the further push element in engagement with a rear clip of the print bed assembly;

FIG. 11 schematically shows a perspective view of a print bed assembly according to another embodiment in the engaged state;

FIG. 12 schematically shows a perspective view of the print bed assembly in the blocked state;

FIG. 13 schematically shows a perspective view of a print bed assembly in the disengaged state; and

FIG. 14-17 show perspective views of part of the assembly in different states showing just one corner of the build plate and one of the handles.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

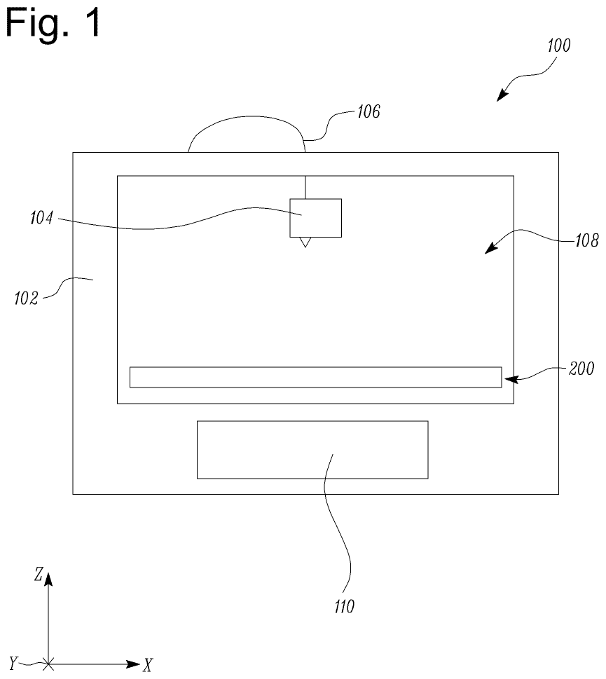

FIG. 1 schematically shows a front view of an additive manufacturing system 100, according to an embodiment of the present invention. The additive manufacturing system 100 comprises a housing 102 and a print head 104 arranged in the housing 102. The housing 102 may be generally box shaped and defines a hollow space 108 also referred to a build chamber 108. A display 110 is arranged at a front side of the housing 102 for displaying information on a print job and for receiving user instructions. The additive manufacturing system 100 is arranged to build parts/components in a layer-by-layer manner using information from a software model, such as, a computer-aided design (CAD) model. The print head 104 may comprise at least one extruder (not shown) that may receive a consumable material, such as, a filament 106. The filament 106 may comprise a thermoplastic material. The consumable material may be melted by the at least one extruder and the molten consumable material may be utilized to produce the parts/components. The print head 104 may be movable along an X-axis and/or a Y-axis.

The additive manufacturing system 100 also comprises a print bed assembly 200. The additive manufacturing system 100 may deposit the consumable material from the print head 104 onto the print bed assembly 200 in the layer-by-layer manner to form a three-dimensional (3D) printed object. The print bed assembly 200 is received within the hollow space 108 of the housing 102. Further, the print bed assembly 200 may be vertically spaced apart from the print head 104. The print bed assembly 200 may be movable along a Z-axis. In some other examples, the print bed assembly 200 may be stationary and the print head 104 may be movable along the Z-axis in addition to the X-axis and/or the Y-axis. It should be noted that the additive manufacturing system 100 may comprise any arrangement of components that may synchronously operate to manufacture the 3D printed object, without any limitations.

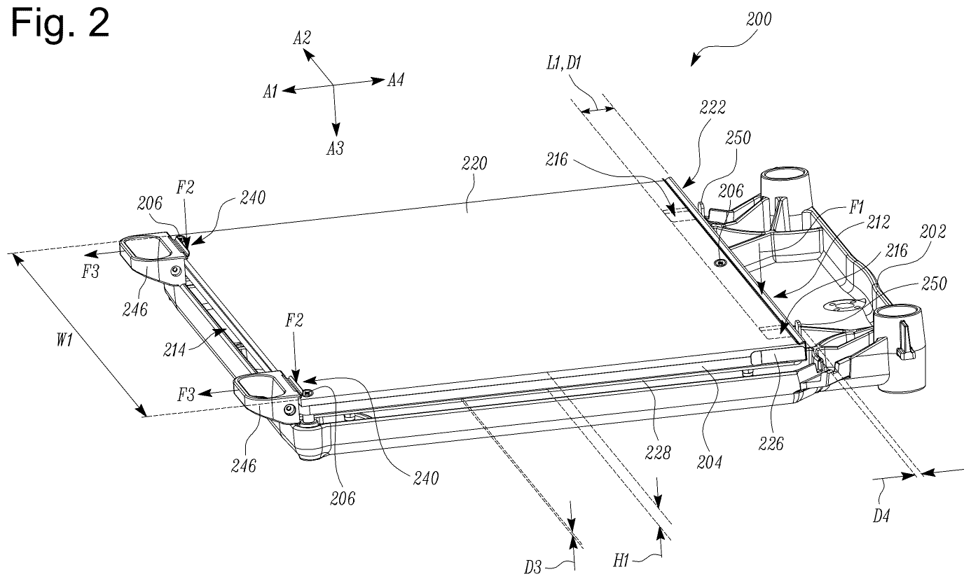

FIG. 2 schematically shows a perspective view of the print bed assembly 200 according to an embodiment. The print bed assembly 200 comprises a stage 202. The stage 202 may be embodied as a base of the print bed assembly 200. It should be noted that the stage 202 may comprise any arrangement of elements that may allow mounting of one or more components of the print bed assembly 200. The stage 202 may be movable in order to effectuate a movement of the print bed assembly 200. Specifically, the stage 202 may be coupled to one or more driving means to vertically move the stage 202. The stage 202 may also be guided by one or more rods extending through holes at the back of the stage 202. In this embodiment, the stage 202 comprises a generally rectangular shape herein. Alternatively, the stage 202 may be realized in any shape, such as a square shape, without any limitations. Further, the stage 202 may be made of any suitable material such as metal. In an example, the stage 202 may comprise one or more fastening elements (not shown) that may movably couple the stage 202 with the housing 102 (see FIG. 1).

The print bed assembly 200 further comprises a carrier plate 204 coupled to and spaced apart from the stage 202. The carrier plate 204 is coupled to the stage 202 via a number of mechanical fasteners 206 (only three of which are illustrated herein). The mechanical fasteners 206 may comprise a screw, a bolt, a pin, and the like. Further, the carrier plate 204 extends in a first direction A1 from a rear side 212 of the carrier plate 204 to a front side 214 of the carrier plate 204 and extends in a second direction A2 which is perpendicular to the first direction A1. In the illustrated embodiment of FIG. 2, the carrier plate 204 is generally rectangular in shape. Alternatively, the carrier plate 204 may have any other shape, such as, a square shape. The carrier plate 204 may be made of any suitable material including, but not limited to, metals, ceramics, and polymers. The carrier plate 204 has a width W1 along the second direction A2.

The print bed assembly 200 further comprises a build plate 220. The consumable material may be deposited on the build plate 220 to form the 3D printed object. The build plate 220 is removably arranged on the carrier plate 204. The build plate 220 and the carrier plate 204 define a combined height H1 as indicated in FIG. 2.

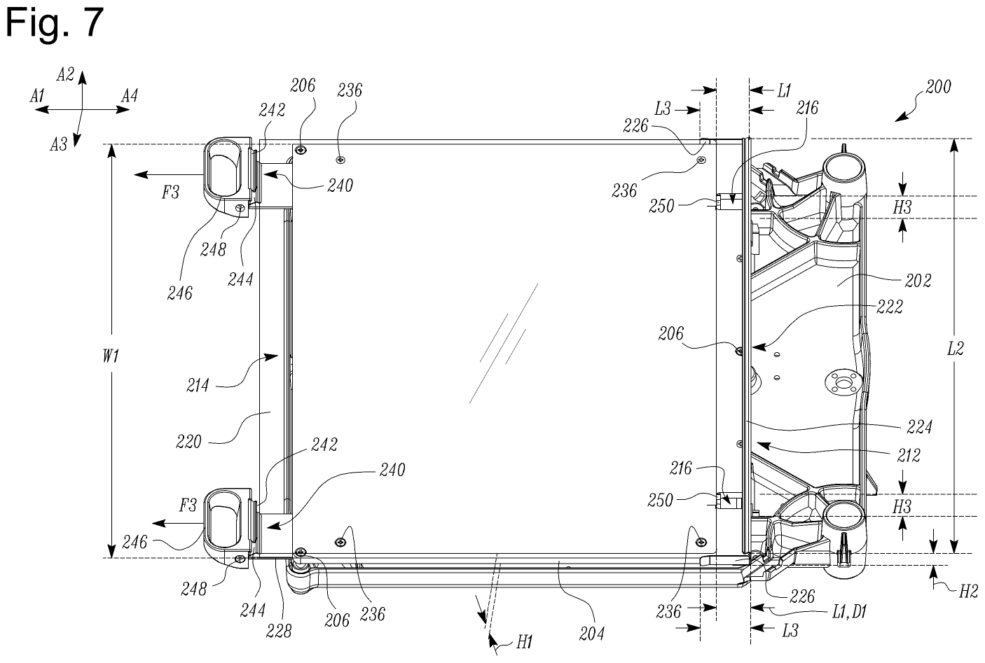

The build plate 220 may be moved over the carrier plate 204 between an engaged state (as illustrated in FIG. 2) and a disengaged state (as illustrated in FIG. 7). In the engaged state, the build plate 220 is clamped onto the carrier plate 204. In the disengaged state of the build plate 220 it can be picked up from the carried plate 204 so as to remove the build plate 220 from the print bed assembly 200.

In the example of FIG. 2, the build plate 220 is made of transparent glass. As a result, the fasteners 206 are visible through the build plate 220. Alternatively, any other suitable material, such as non-transparent glass or metal, may be used to manufacture the build plate 220.

In the embodiment of FIG. 2, the build plate 220 is a rectangular plate with rounded corners. Alternatively, the build plate 220 may comprise any other shape suitable for building an object on. Preferably, the dimensions of the build plate 220 are similar to the dimensions of the carrier plate 204, wherein in the engaged state, at least the rear edge and the front edge of the build plate 220 are aligned with the respective edges of the carrier plate 204. In this way, the build plate 220 is fully supported, and clips can be attached at the front and rear sides of the build plate 220 which clips also contact the carrier plate 204.

The print bed assembly 200 further comprises one rear clip 222 arranged to detachably couple the build plate 220 with the carrier plate 204 at the rear side 212 of the carrier plate 204. In this example the rear clip 222 extends along the second direction A2. The rear clip 222 is arranged to clamp the build plate 220 on the build plate 220 using a first clamping force F1. The rear clip 222 described herein may reduce a susceptibility to failure of the rear clip 222, such as due to plastic deformation, and may also allow easy engagement and disengagement of the build plate 220 therewith. The assembly 200 may comprise more than one rear clip, such as two or three, or even more.

The print bed assembly 200 further comprises a slide body 228 slidably arranged between the stage 202 and the carrier plate 204. In this example, the print bed assembly 200 further comprises two front clips 240 arranged to detachably couple the build plate 220 with the carrier plate 204 at the front side 214 of the carrier plate 204. The front clips 240 are coupled to the slide body 228. Each of the front clips 240 is arranged to apply a second clamping force F2 on the build plate 220 as indicated in FIG. 2. The print bed assembly 200 further comprises two handles 246 coupled to the slide body 228 and arranged at the front side 214 of the carrier plate 204. The print bed assembly 200 further comprises two push elements 250 coupled to the handles 246 via the slide body 22. The push elements 250 are arranged to push the build plate 220 over the carrier plate 204 only after the slide body 228 is moved by a predefined distance D4 in the first direction A1. The distance D4 is the distance, defined along the first direction A1, between the rear edge of the build plate 220 and the at least one push element 250, when the build plate 220 is in the engaged state and the slide body 228 is in the initial position shown in FIG. 2.

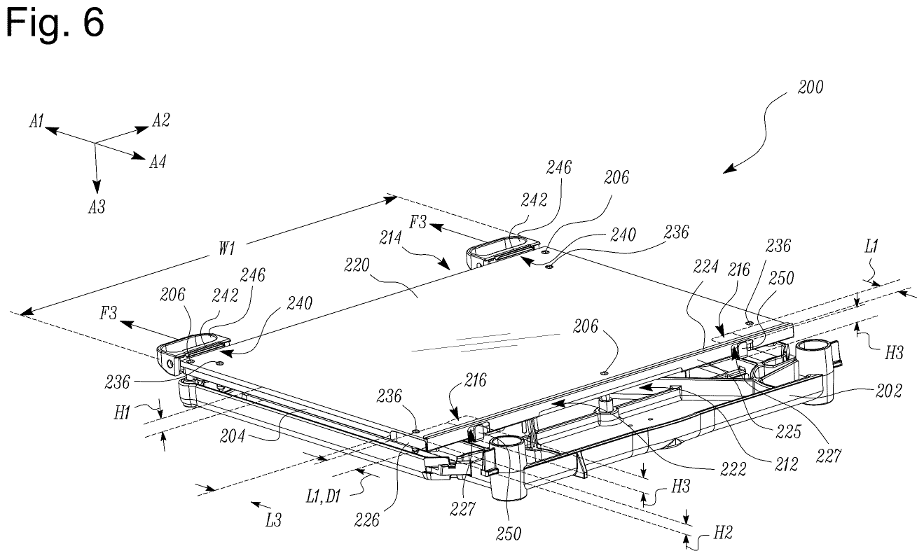

A user may apply a pulling force F3 in the first direction A1 on the handles 246 for moving slide body 228 in the first direction A1. By moving the slide body 228, the connected push elements 250 are moved between a first position (as illustrated in FIG. 2), a second position (as illustrated in FIG. 6), and a third position (as illustrated in FIG. 7). Upon application of the pulling force F3 on the handles 246, the push elements 250 will move in the first direction A1 from the first position to the second position. When the build plate 220 is in the engaged state (i.e., still clamped by the front and rear clips 240, 222), the push elements 250 are in the first position (i.e., most backward position). In the first position, the push elements 250 are spaced apart from the rear side 212 of the carrier plate 204 by at least the predefined distance D4.

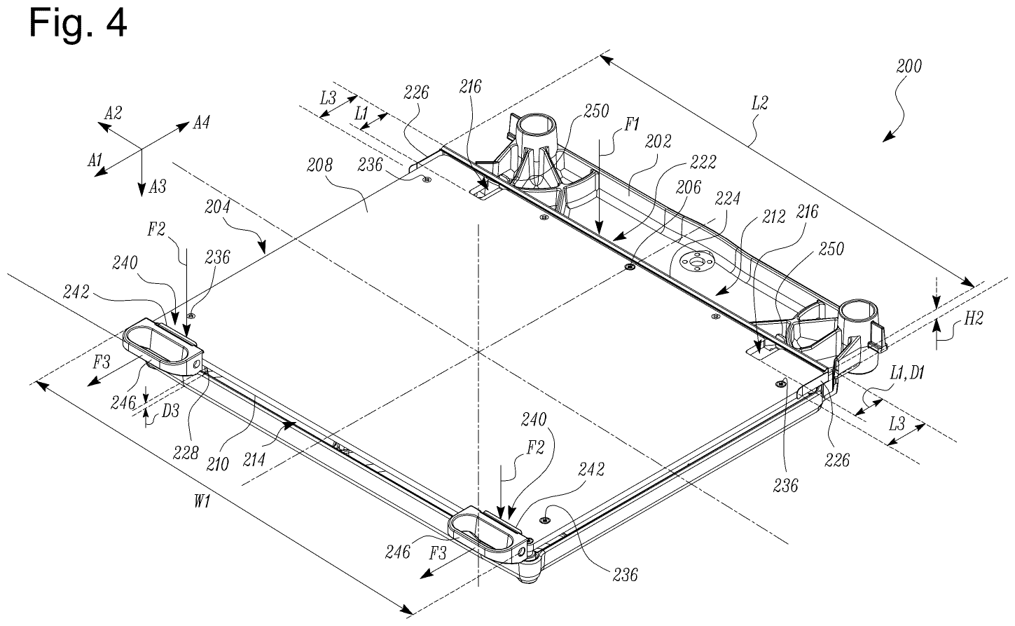

In an embodiment, the sum of the clamping forces F2 applied by the two front clips 240 (i.e. 2>F2) is less than the first clamping force F1 applied by the single rear clip 222. As a result, once the user pulls at the handles 246, the front clips 240 will certainly be released first. Only after the handles 246 are pulled sufficiently far, the push elements 250 will move the build plate 220 out of the rear clip 222 so that the complete build plate 220 is released from all the clips 240, 222, and in a suitable sequence, see also the below description of FIGS. 4, 6 and 7.

The print bed assembly 200 of FIG. 2 further comprises a pair of side guides 226 arranged to couple with each of the carrier plate 204 and the build plate 220. In the engaged state, the build plate 220 is constrained sideways by the pair of side guides 226. Specifically, the pair of side guides 226 may restrict any movement of the build plate 220 in the second direction A2. The pair of side guides 226 may also centrally align the build plate 220. Further, during the removal and/or the installation of the build plate 220, the build plate 220 may be guided by the pair of side guides 226 so that the build plate 220 may be self-centred. The pair of side guides 226 are spaced apart from each other along the second direction A2. In this example, each of the pair of side guides 226 extends from the rear clip 222. The pair of side guides 226 extend along the first direction A1. In some examples, the pair of side guides 226 may be fixedly coupled to the rear clip 222. The side guides 226 may be embodied as rectangular plates. In an example, a height H2 of the side guides 226 may be at least equal to the combined height H1 (see FIG. 2) of the carrier plate 204 and the build plate 220, so that the side guides 226 may engage with the carrier plate 204 as well as the build plate 220.

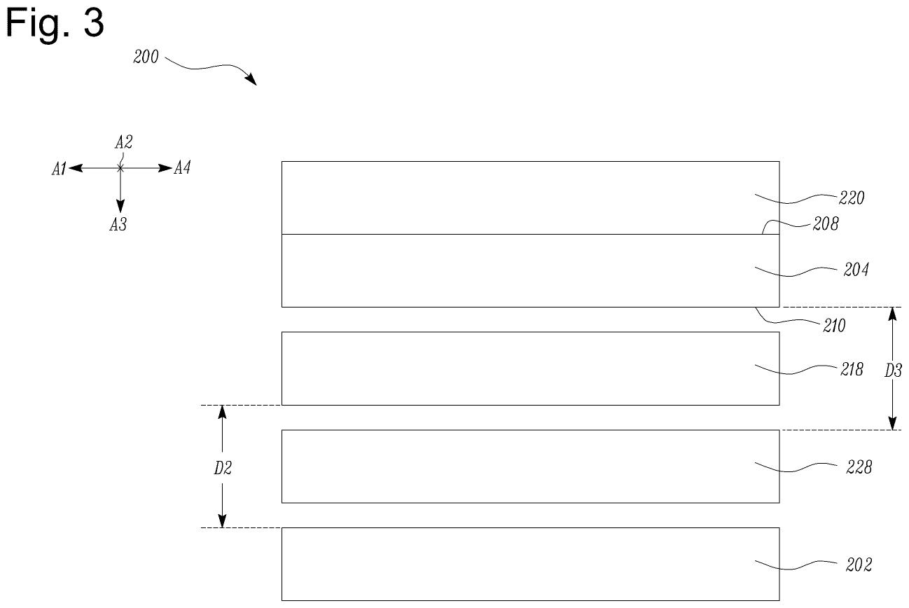

FIG. 3 shows a schematic front view of the elements of the print bed assembly 200 according to an embodiment. It should be noted that the distances between various components of the print bed assembly 200 are shown in an exaggerated manner in FIG. 3 for illustrative purposes. Furthermore, the relative dimensions of the elements shown in FIG. 3 will be different in practice, and will not be equal, like it seems to look from the drawing.

As illustrated in FIG. 3, the print bed assembly 200 may further comprise a heating element 218 arranged under or in the carrier plate 204. For illustrative purposes, the heating element 218 is shown in a spaced apart manner from the carrier plate 204. The heating element 218 may maintain a temperature of one or more components of the print bed assembly 200, such as, the carrier plate 204 or the build plate 220 at a desired temperature level. The heating element 218 is disposed between the carrier plate 204 and the stage 202. The heating element 218 is disposed at a distance D2 from the stage 202. The distance D2 may lie in a range from 1 mm to 3 mm. In an example, the distance D2 may be approximately equal to 2 mm. In some examples, the heating element 218 may comprise a silicone heater mat, a heating coil, a resistance wire, a resistance film, a resistor disc, and the like. The heating element 218 may be arranged to heat an entire area of the carrier plate 204. Thus, dimensions of the heating element 218 may be substantially similar to the dimensions of the carrier plate 204.

Further, the carrier plate 204 comprises a first surface 208 and a second surface 210 opposite the first surface 208. When the build plate 220 is arranged on the carrier plate 204, the build plate 220 will contact the first surface 208 of the carrier plate 204. Moreover, the second surface 210 faces the heating element 218, the slide body 228, and the stage 202. The first and second surfaces 208, 210 may have a generally planar profile. Further, the carrier plate 204 is spaced apart from the slide body 228 by a vertical offset D3 in a third direction A3 perpendicular to the first and second directions A1, A2. The vertical offset D3 between the carrier plate 204 and the slide body 228 may lie in a range of 1 mm to 4 mm. It should be noted that the vertical offset D3 may be obtained such that the slide body 228 may be movable along the first direction A1 and along the direction A4 without interfering with any other component of the print bed assembly 200. Moreover, the vertical offset D3 between the carrier plate 204 and the slide body 228 may be such that the heating element 218 does not interfere with the slide body 228.

FIG. 4 schematically shows a perspective view of the print bed assembly 200. The build plate 220 (see FIG. 2) is not shown in FIG. 4 for illustrating various features of the carrier plate 204. As illustrated in FIG. 4, the carrier plate 204 comprises two cut-outs 216 disposed at the rear side 212 and aligned with each of the push elements 250. It should be noted that the carrier plate 204 may comprise more than two cut-outs or a single cut-out similar to the cut-outs 216, without any limitations. Further, the cut-outs 216 are generally rectangular in shape. Alternatively, the cut-outs 216 may be realized in any shape, such as a square shape, without any limitations. The cut-outs 216 have a cut-out length L1. In an embodiment, the cut-out length L1 of the cut-outs 216 may vary from 10 mm to 15 mm. It should be noted that the distance D1 is the distance defined along the first direction A1 between a location where the push elements 250 abut the build plate 220 and a location where the push elements 250 abut the carrier plate 204. In some embodiments, the cut-out length L1 may be equal to the distance D1. In some examples, the carrier plate 204 may omit the cut-outs 216.

In the embodiment shown in FIGS. 2 and 4, each of the pair of side guides 226 has a guide length L3 that is slightly greater than the distance D1. In this way, even when the build plate 220 moves by the distance D1, the build plate 220 may still be in engagement with the side guides 226. It should be noted that the guide length L3 of each side guide 226 as illustrated herein is exemplary in nature. Accordingly, the guide length L3 of the side guides 226 may be greater than that illustrated herein, without any limitations. In some examples, the print bed assembly 200 may omit the side guides 226.

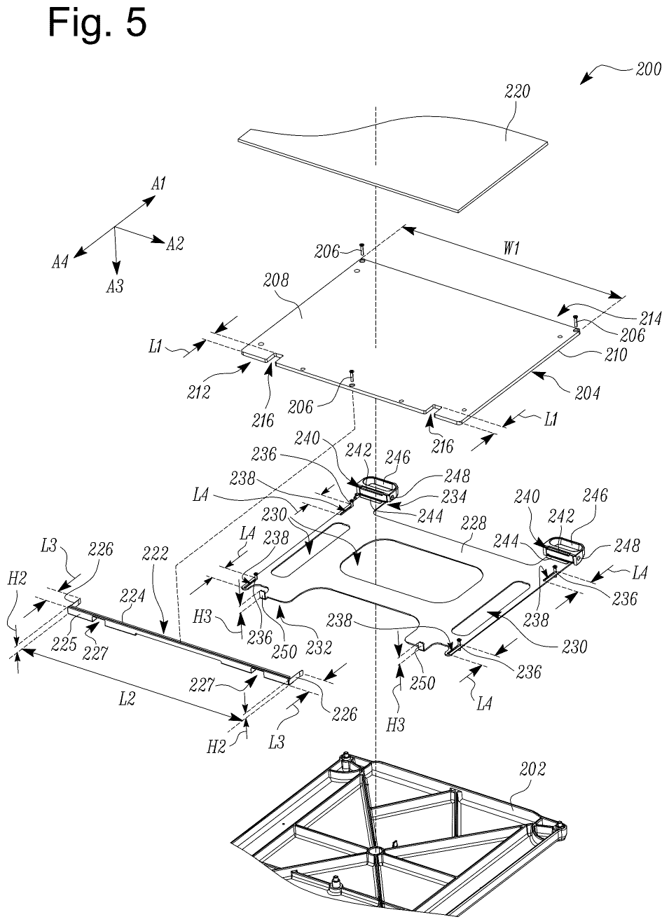

FIG. 5 illustrates an exploded view of the print bed assembly 200. As illustrated in FIG. 5, the print bed assembly 200 comprises a single rear clip 222 that extends in the second direction A2. In other examples, the print bed assembly 200 may comprise two or more rear clips that may be spaced apart from each other along the second direction A2, without any limitations. The rear clip 222 has a length L2 that may be substantially equal to the width W1 of the carrier plate 204. The rear clip 222 may comprise a leaf spring. For example, the rear clip 222 may comprise a bistable leaf spring. The rear clip 222 comprises an upper portion 224, an intermediate portion 225, and a lower portion (not shown). The lower portion is vertically spaced apart from the upper portion 224 along the third direction A3, such that a portion of the build plate 220 and the carrier plate 204 can be received therebetween. The upper portion 224 may be embodied as a continuous element. The upper portion 224 may comprise a leaf spring. Further, when the build plate 220 is in the engaged state (as illustrated in FIG. 2), the upper portion 224 engages with the build plate 220 to hold the build plate 220 in the engaged state.

Moreover, the intermediate portion 225 may embody a discontinuous element defining gaps 227 therebetween. The gaps 227 are provided to allow passage of the push elements 250 during the movement of the slide body 228. Further, the lower portion may also embody a discontinuous element defining gaps (not shown) therebetween. The gaps in the lower portion are provided to allow passage of the push elements 250 during the movement of the slide body 228.

In an example, the intermediate portion 225 and the lower portion may comprise a leaf spring. In other examples, the intermediate portion 225 and the lower portion may comprise a rectangular plate. Further, the lower portion of the rear clip 222 engages with the carrier plate 204. In some examples, the lower portion of the rear clip 222 may be coupled to the carrier plate 204 using mechanical fasteners (not shown). In some examples, the upper portion 224, the intermediate portion 225, and the lower portion of the rear clip 225 may together have a substantially U-shaped cross-section for engaging the build plate 220 with the carrier plate 204. It should be noted that the rear clip 222 may comprise any other design or shape that may allow easy engagement and disengagement of the build plate 220 therewith, without limiting the scope of the present invention.

Further, the slide body 228 comprises a first end 232 and a second end 234. The slide body 228 comprises a flat thin plate with a number of openings 230 in it. The openings 230 may reduce a weight of the slide body 228, and/or may give space to protruding elements. Moreover, the openings 230 may limit a temperature increase of the slide body 228 due to heat radiated by the heating element 218 (see FIG. 3). The slide body 228 may be made of any material including, but not limited to, metals, ceramics, or polymers. In some examples, the slide body 228 may be made from a sheet metal.

The print bed assembly 200 further comprises guiding members 236 at least partially arranged between the stage 202 and the carrier plate 204. The slide body 228 may be guided by the guiding member 236 during a movement of the slide body 228 relative to the carrier plate 204. Specifically, the guiding members 236 may guide the slide body 228 in the first direction A1. Moreover, the guiding member 236 may also ensure an alignment of the slide body 228 relative to the carrier plate 204 and the stage 202. Further, in some examples, the guiding members 236 may also connect the carrier plate 204 with the stage 202. In this example, the assembly 200 comprises four guiding members 236 arranged in all four corners of the slide body 228 so as to guide the slide body 228 in a controlled direction, avoiding any unwanted rotation. Further, the guiding members 236 are embodied as mechanical fasteners herein. The guiding members 236 may comprise bolts, screws, pins, and the like. Alternatively, the guiding members 236 may comprise any other shape or design, without any limitations.

Each of the guiding members 236 is at least partially and slidably received within a respective slot 238 of the slide body 228. The slots 238 may define a movement path of the at least one guiding member 236 and may also restrict any movement of the at least one guiding member 236 beyond a desired distance. In the illustrated embodiment of FIG. 5, the slide body 228 comprises four slots 238, each of which receive a corresponding guiding member 236. In some examples, a length L4 of each slot 238 may be at least equal to or more than the cut-out length L1 of the cut-out 216 provided in the carrier plate 204. It should be noted that the present invention is not limited by a total number of the guiding members 236 or a total number of the slots 238. It should be further noted that the mechanical fasteners 206 that connect the carrier plate 204 with the stage 202 may be disposed such that the slide body 228 does not interfere with the mechanical fasteners 206 during the movement of the slide body 228 in the first direction A1 or the direction A4.

Further, as illustrated in FIG. 5, the assembly 200 comprises two front clips 240 that are spaced apart from each other along the second direction A2. Each front clip 240 comprises an upper portion 242 and a lower portion 244 vertically spaced apart from the upper portion 242 for receiving a portion of the build plate 220 and the carrier plate 204 therebetween. In an example, the upper and lower portions 242, 244 of each front clip 240 may be embodied as a leaf spring. Alternatively, the upper and lower portions 242, 244 may comprise any other design or shape, without any limitations. When the build plate 220 is in the engaged state, the upper portion 242 of each front clip 240 may engage with the build plate 220 and the lower portion 244 of each front clip 240 may engage with the carrier plate 204. Moreover, in the disengaged state of the build plate 220, the upper portion 242 of each front clip 240 may be disengaged from the build plate 220 and the lower portion 244 of each front clip 240 may be disengaged from the carrier plate 204.

In some examples, a length of the lower portion 244 defined along the first direction A1 may be longer than a length of the upper portion 242 defined along the first direction A1. In such examples, when the build plate 220 is being installed, the lower portion 244 may first engage with the carrier plate 204 followed by the engagement of the upper portion 242 with the build plate 220. In some examples, the upper portion 242 and the lower portion 244 may have same elastic properties. However, the upper portion 242 and the lower portion 244 may have different elastic properties. It should be noted that the front clips 240 may comprise any other design or shape that may allow easy engagement and disengagement of the build plate 220 therewith.

Further, the assembly 200 comprises two handles 246 that are spaced apart from each other along the second direction A2. The handles 246 may be similar in design. In other examples, the print bed assembly 200 may comprise a single handle coupled to the slide body 228. Each handle 246 is coupled to the slide body 228 using a pair of mechanical fasteners 248 (only one of which is illustrated herein). The mechanical fasteners 248 may comprise screws, pins, bolts, and the like. Alternatively, each handle 246 may be welded to the slide body 228. In some other examples, each handle 246 may form an integral part of the slide body 228.

The handles 246 may be made of a polymer, a ceramic, and the like. It should be noted that, in some examples, a connection of the handles 246 with the slide body 228 and the front clips 240 may be equipped with a heat break. Further, the handles 246 may be made from a polymer that may exhibit a lower heat deflection temperature. The handles 246 may have a square cross section, a rectangular cross-section, a circular cross-section, and the like. The handles 246 may have an ergonomic design such that the handles 246 may be convenient for the user to grab. Moreover, as the handles 246 may conduct heat from the slide body 228 which may in turn be heated by the heating element 218, the handles 246 may comprise an insulated covering so that the user can easily hold the handles 246 for removing the build plate 220.

Further, as illustrated in FIG. 5, the push elements 250 extend in the third direction A3 from the slide body 228. Specifically, the push elements 250 extend perpendicularly from the slide body 228. In the illustrated embodiment of FIG. 5, the push elements 250 are integral with the slide body 228. In such examples, the slide body 228 and the push elements 250 may form a single piece unit. Further, the push elements 250 comprises two push elements 250 that are spaced apart from each other along the second direction A2. In other examples, the print bed assembly 200 may comprise more than two push elements or a single push element similar to the push element 250, without any limitations.

The push elements 250 are embodied as rectangular plates herein forming a hook or lip arranged on the slide body 228. Alternatively, the push elements 250 may comprise square plates. Further, the push elements 250 may have another structure, such as, an L-shaped structure, a C-shaped structure, and the like, without any limitations. When the push elements 250 comprise the L-shaped structure or the C-shaped structure, the carrier plate 204 may omit the cut-outs 216, such that the push elements 250 may directly engage with the build plate 220 for pushing the build plate 220 in the first direction A1. Moreover, in some examples, the push elements 250 may comprise mechanical fasteners, such as, bolts, screws, pins, and the like, that may be coupled with the slide body 228.

In the example of FIG. 5 each push element 250 has a height H3. Further, the height H3 of the push elements 250 may be defined such that the push elements 250 can easily pass the gaps 227 of the rear clip 222, so that the push elements 250 do not engage with the rear clip 222 during the movement of the push elements 250 in the first direction A1 or the direction A4. Moreover, the height H3 of each push element 250 may be obtained such that, in the engaged state of the build plate 220, the push elements 250 may engage with rear side of the build plate 220.

With reference to FIG. 6, upon application of the pulling force F3 on the handles 246, the front clips 240 first detach from the build plate 220 and the carrier plate 204, and allow the (further) movement of the slide body 228 relative to the carrier plate 204. The pulling force F3 applied by the user may deform the upper portion 242 and the lower portion 244 (see FIG. 5) of each front clip 240, thereby disengaging the front clips 240 from the build plate 220 and the carrier plate 204. FIG. 6 shows the push elements 250 in the second position. In this second position, the push elements 250 abut the build plate 220. It should be noted that the build plate 220 and the carrier plate 204 will still be in contact with the rear clip 222 when the push elements 250 abut the build plate 220. It should further be noted that, in the second position of the push elements 250, also the pair of side guides 226 are in contact with the build plate 220. After the slide body 228 is moved (i.e. pulled) further than the predefined distance D4 (see also FIG. 2), the push elements 250 push the build plate 220 further, thereby detaching the build plate 220 from the rear clip 222.

Once the build plate 220 detaches from the rear clip 222, the build plate 220 may rest freely on the carrier plate 204, possibly still guided by the side guides 226. Further, after the slide body 228 is moved further than the predefined distance D4, each of the cut-outs 216 at least partially receives one of the push elements 250 therein. As the cut-outs 216 receive the push elements 250 therein and allow some travel of the push elements 250 in the first direction A1, the build plate 220 may move by a sufficient distance in the first direction A1, thereby allowing easy removal of the build plate 220. The user does not have to exert any additional force on the front clips 240 nor on the rear clip 222, so that the risk of plastic deformation of the front clips 240 and rear clip 222 is reduced.

FIG. 7 schematically shows the at least one push element 250 in the third position. Specifically, a continual application of the pulling force F3 causes the slide body 228 to move in the first direction A1 such that the push elements 250 moves from the second position to the third position. Further, in the third position of the push elements 250, the pair of side guides 226 are in contact with the build plate 220 thereby keeping the build plate 220 centred. Moreover, the movement of the slide body 228 causes the push elements 250 to move by the distance D1 until the push elements 250 abut the carrier plate 204. The push elements 250 are arranged to move the build plate 220 by the distance D1 in the first direction A1 such that the distance D1 is equal to the cut-out length L1 of the at least one cut-out 216. Further, as the cut-out length L1 may vary from 10 mm to 15 mm, the distance D1 by which the push elements 250 may travel in the first direction A1 may also vary from 10 mm to 15 mm. It should be noted that the cut-out length L1 and the distance D1 may be obtained such that the build plate 220 can be easily removed and/or installed. In some examples, the cut-out length L1 and the distance D1 may be based on a size of the additive manufacturing system 100 (see FIG. 1). Thus, in some examples, the cut-out length L1 and the distance D1 may be greater than 15 mm. Further, the movement of the build plate 220 by the distance D1 may allow for convenient handling of the build plate 220 by the user for removing and/or installing the build plate 220. Moreover, the user may remove the build plate 220 using bare hands or using any protective means, such as, gloves. In other examples, the user may use a tool for removing the build plate 220.

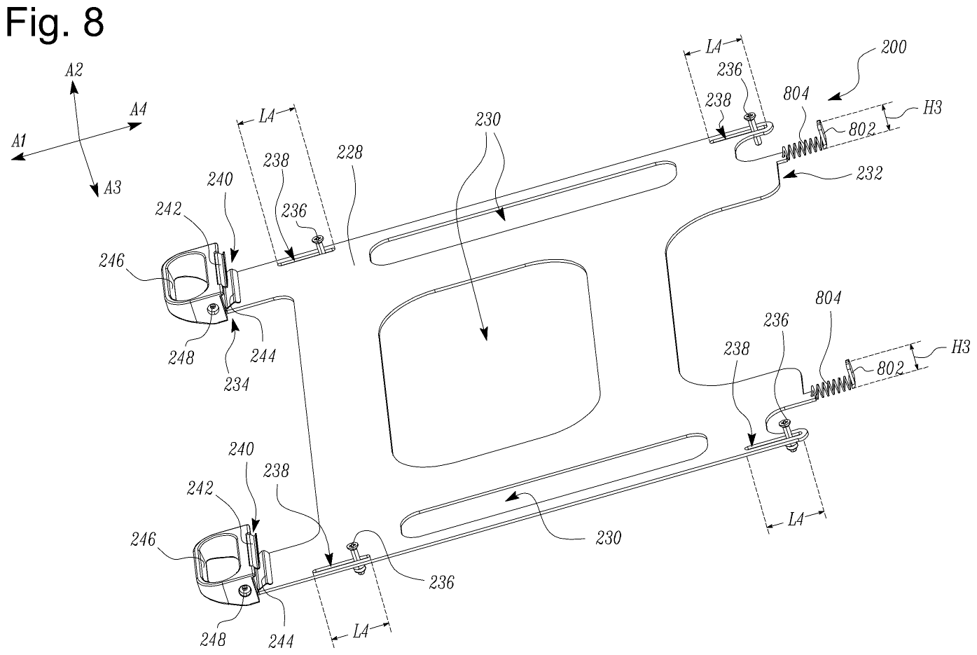

After removing the build plate 220, the user may desire to reinstall the build plate 220 in the engaged state. For moving the build plate 220 to the engaged state, the user may first place the build plate 220 on the carrier plate 204. Due to the design of the slide body 228 and the side guides 226, a placement of the build plate 220 on the carrier plate 204 may cause the build plate 220 to contact the pair of side guides 226. Subsequently, the user may hold the handles 246 to move the slide body 228 in the direction A4 (i.e. opposite direction of A1) until the build plate 220 engages with the rear clip 222. The engagement of the build plate 220 with the rear clip 222 may dispose the build plate 220 in the engaged state. Thus, the print bed assembly 200 described herein may allow easy engagement and disengagement of the build plate 220. Further, the design of the print bed assembly 200 may prevent failures of the front clips 240 and the rear clip 222 during the removal and/or the installation of the build plate 220. The print bed assembly 200 described herein may exhibit improved reliability and may also increase an efficiency of the additive manufacturing system 100 (see FIG. 1). Moreover, the print bed assembly 200 makes the additive manufacturing system 100 user-friendly. FIG. 8 illustrates the slide body 228 and the handles 246 according to another embodiment of the present invention. In this embodiment, the slide body 228 is coupled to two push elements 802 but is a different manner as compared to the push elements 250 explained in relation to FIGS. 5, 6, and 7. In the illustrated embodiment of FIG. 8, the print bed assembly 200 further comprises flexible members 804 coupling each of the push elements 802 with the slide body 228. Each flexible member 804 is embodied as a coil spring herein. Alternatively, the flexible members 804 may comprise any other type of flexible devices known in the art. In some examples, the flexible members 804 and the push elements 802 may be separate components joined to the slide body 228 by any suitable joining methods. In some other examples, the push elements 802 and the flexible members 804 may be integral with the slide body 228.

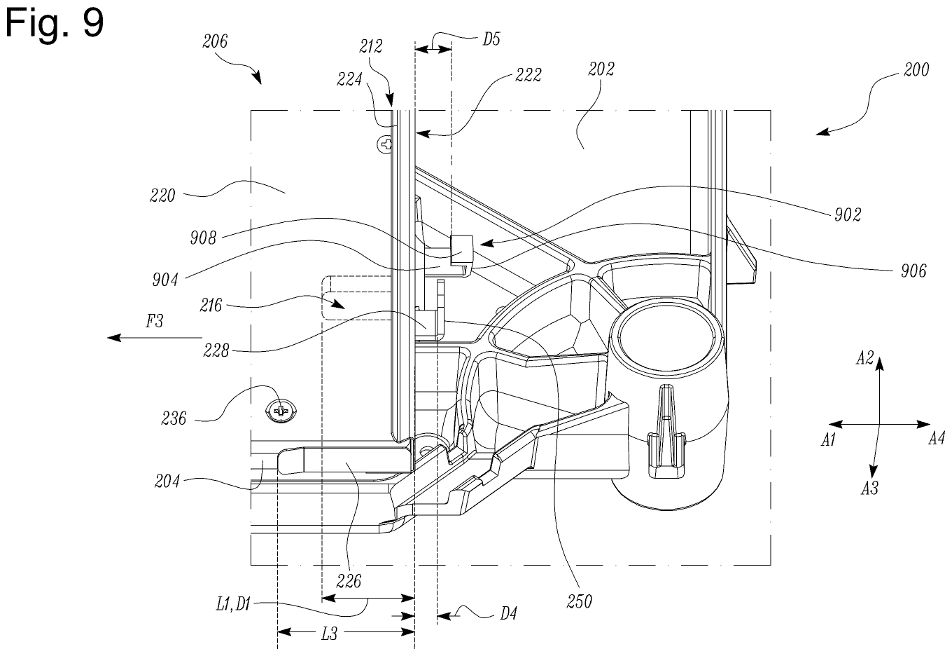

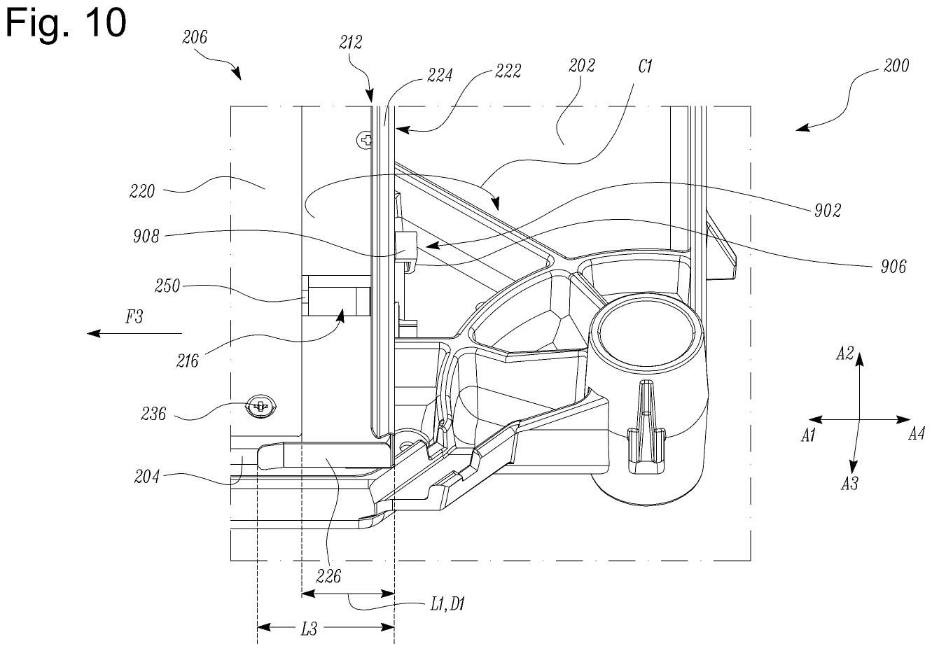

FIGS. 9 and 10 illustrate details of another exemplary embodiment of the present invention. A portion of the print bed assembly 200 explained in reference to FIGS. 1-7 is illustrated in FIGS. 9 and 10. FIG. 9 illustrates the build plate 220 in the engaged state. As shown in FIG. 9, the print bed assembly 200 further comprises a further push element 902 coupled to the handles 246 (see FIG. 5) via the slide body 228. The further push element 902 extends from the slide body 228. Further, the further push element 902 is spaced apart from the at least one push element 250 in the second direction A2. The print bed assembly 200 may comprise two further push elements 902 (only one of which is illustrated herein) that may be spaced apart from each other along the second direction A2. In an example, the further push elements 902 may be integral with the slide body 228. Alternatively, each of the further push elements 902 may embody a separate component that may be coupled with the slide body 228 using suitable joining methods.

Further, each of the further push elements 902 comprises a first element 904, a second element 906, and a third element 908. The first element 904 of the further push element 902 extends in the first direction A1. The second element 906 of the further push element 902 extends in the third direction A3. The first element 904 and the second element 906 are embodied as rectangular plates that together form an L-shaped structure. Further, the third element 908 extends perpendicular to the second element 906 and is parallel to the first element 904. The third element 908 comprises a rectangular plate. It should be noted that the further push element 902 may be realized in any other design, without any limitations. When the build plate 220 is in the engaged state, the third element 908 of the further push element 902 is spaced apart from the rear clip 222 by a distance D5.

FIG. 10 illustrates the build plate 220 in the disengaged state. Referring to FIG. 10, upon application of the pulling force F3 on the at least one handle 246 (see FIG. 7), the push elements 250 and the further push elements 902 may move in the first direction A1. It should be noted that, when the push elements 250 move by the predefined distance D4 (see FIG. 9) and the push elements 250 abut the build plate 220, the further push elements 902 may still be spaced apart from the rear clip 222 along the first direction A1. Further, the further push elements 902 are arranged to engage the rear clip 222 after the slide body 228 moves in the first direction A1 by the distance D5 (see FIG. 9) greater than the predefined distance D4, in order to open the rear clip 222. Specifically, upon application of the pulling force F3, the push elements 250 may move by the distance D1. At the same time, the further push elements 902 may abut the at least one rear clip 222 and may apply a force on the rear clip 222 to open the rear clip 222. Further, the force being applied by the further push element 902 may deform the rear clip 222 to open the rear clip 222. Specifically, the upper portion 224 of the rear clip 222 may move in a clockwise direction C1 causing the rear clip 222 to move to an open position. The at least one rear clip 222 may remain in the open position until the further push element 902 is in contact with the rear clip 222. This may facilitate reinstallation of the build plate 220.

Further, during the installation of the build plate 220, the further push elements 902 may move in the direction A4. As the further push elements 902 disengage from the rear clip 222, the rear clip 222 may bias towards a closed position. Moreover, as the build plate 220 is pushed towards the rear clip 222, the build plate 220 may engage with the rear clip 222 and may be disposed in the engaged state.

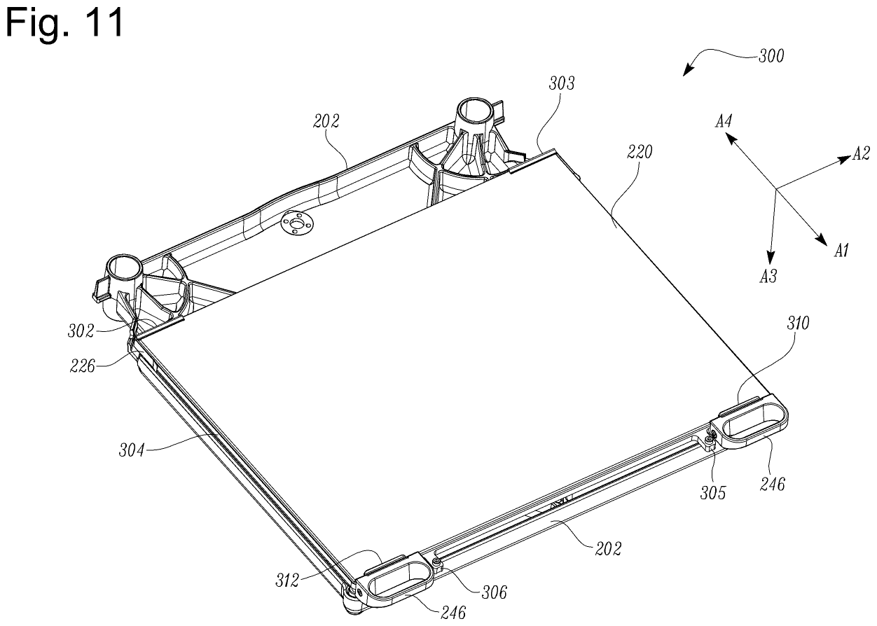

FIG. 11 schematically shows a perspective view of a print bed assembly 300 according to another embodiment. The print bed assembly 300 comprises a stage 202, a build plate 220, and two handles 246 similar to those described above. A carrier plate 304 is arranged between the stage 202 and the build plate 220. The carrier plate 304 differs from the carrier plate 204 (see FIG. 4) as will be explained in more detail below. In this embodiment, the print bed assembly 300 further comprises two rear clips 302, 303 arranged to clamp the build plate 220 onto the carrier plate 304 at the rear side. The build plate 220 is removably arranged on the carrier plate 304. The print bed assembly 300 also comprises two blocking elements 305, 306 arranged at the front side of the carrier plate 304.

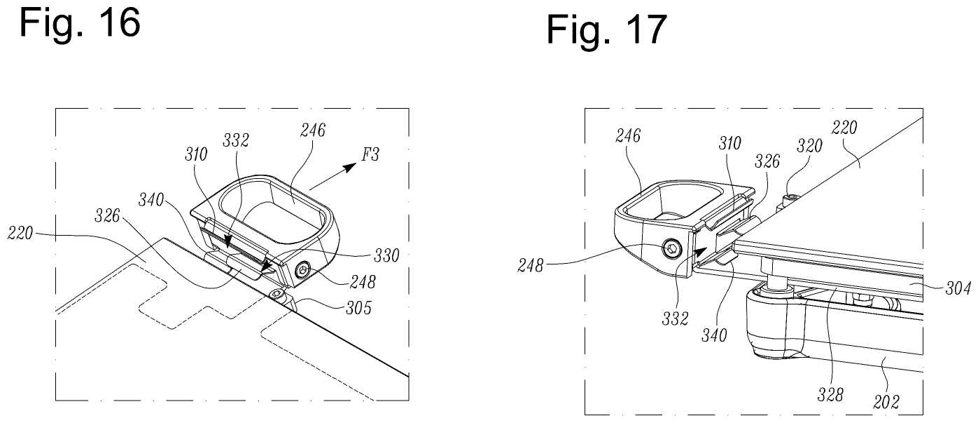

FIG. 11 shows the build plate 220 in the engaged state wherein the build plate 220 is clamped onto the carrier plate 304 by the rear clips 303, 304 and front clips 332, which are shown in more detail in FIGS. 16 and 17. In FIG. 11, some clamp elements 310, 312 of the front clips 332 are indicated. In an embodiment, each of these clamp elements 310, 312 forms part of both one front clip 332 and of one so-called build plate clip (not visible in FIG. 11), which build plate clip only clamps onto the build plate 220 and not onto the carrier plate 304.

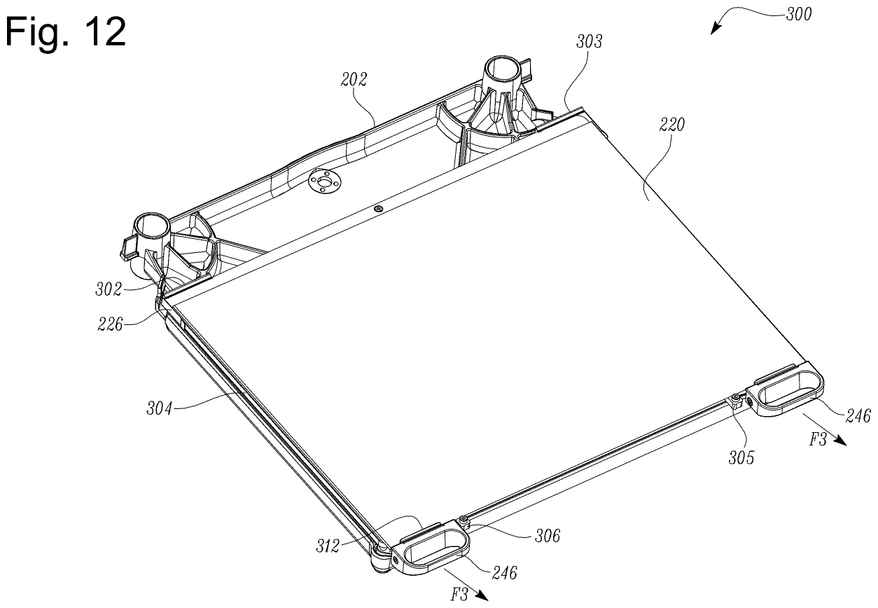

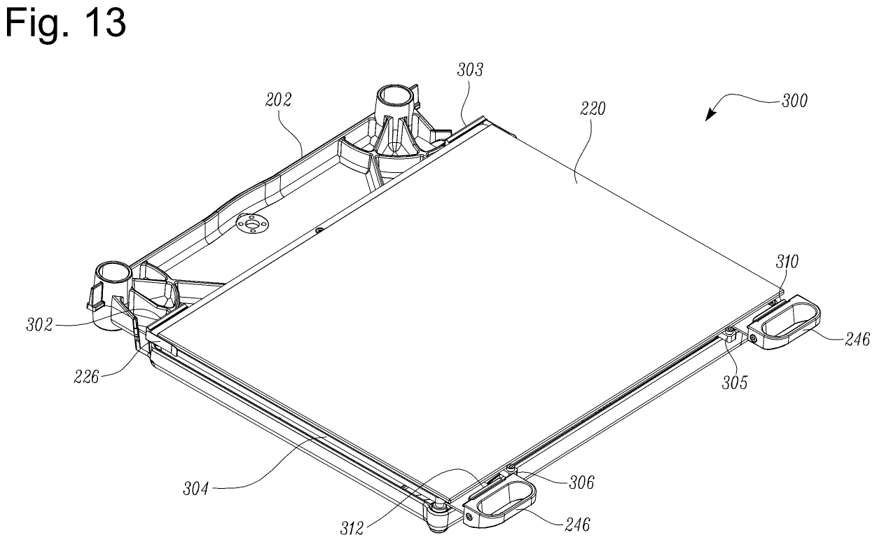

Now, once the user applies a pulling force F3 at both the handles 246, the build plate moves in the first direction A1 until it is blocked by the blocking elements 305, 306, see FIG. 12. In FIG. 12 the build plate 220 is detached from the rear clips 302, 303. If the user pulls the handles 246 further, the build plate 220 will also become complete detached from the clamp elements 310, 312, as is shown in FIG. 13.

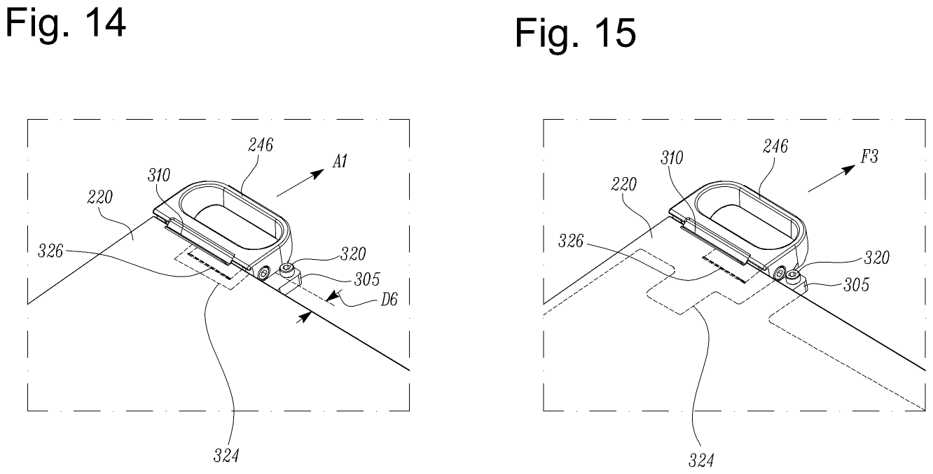

FIG. 14-17 show perspective views of part of the assembly 300 showing just one corner of the build plate 220 and one of the handles 246. FIG. 14 shows the handle 246 and the build plate 220 in the engaged state. In this embodiment, each of the blocking elements 305, 306 comprises an abutment 320 for limiting a movement of the build plate 220 relative to the carrier plate 304 in the first direction A1. The blocking elements 305, 306 may be extensions of the carrier plate 304 having a bolt screwed in it forming the abutment 320. In the engaged state, the abutment 320 is spaced apart from the front side of the build plate 220 over a predefined distance D6, see FIG. 14. In this example, the carrier plate 304 underneath the build plate 220 comprises one or more cut-outs 324 (see dashed lines). This cut-outs 324 enables a clamp element 326 to reach the bottom surface of the build plate 220. The clamp element 326 together with a part of the clamp element 310 function as a build plate clip 330 (see also FIG. 16) arranged to clamp only the build plate 220. The build plate clip 330 is arranged to apply sufficient clamping force onto the build plate 220, so that a frictional force between the clamping elements 310, 326 and the build plate 220 is achieved which overcomes the other frictional forces on the build plate 220 originating from the rear clips 302, 303 and the front clips 332, and possibly other forces such as the forces applied by the side guides 226, and/or gravitational forces on the build plate 220.

FIG. 15 shows the build plate 220 in a blocked state, wherein the build plate 220 is pulled up to the abutments 320. In this state, the build plate 220 has been released from the rear clips 302, 303, see also FIG. 12.

FIG. 16 shows the build plate 220 in a fully disengaged state, wherein the handles 246 are pulled further in the first direction A1, but the build plate 220 cannot move further, resulting in the release of the build plate 220 from the build plate clips 330. In this state, the build plate 220 has been released both from the rear clips 302, 303, and from the build plate clips 330. Now the user can easily pick up the build plate 220.

It is noted that in FIG. 15 the build plate 220 has already been freed by the front clip 332 since the clamp element 340 (not visible in FIG. 15) has slipped of the bottom surface of the carrier plate 304 in this state. However in FIG. 15, the build plate 220 is still hold by the build plate clip(s) 330.

FIG. 17 shows a perspective view from the side of the print bed assembly 300 so as to better show details of the slide body 328. The slide body 328 is slidably arranged between the stage 202 and the carrier plate 304. the slide body 328 comprises a number of slots (not visible in

FIG. 17) similar to the slots 238 shown in FIG. 5. Through these slots, one or more guiding members are arranged, like the members 236 shown in FIG. 5. Due to the slots and guiding members the slide body 328 can move in the directions A1 and A4, but in a limited way. The slide body 328 may look like the slide body 228 shown in FIG. 5 but does not need to extend all the way to the rear side of the assembly 300. In an embodiment, the slide body 328 is arranged to connect the two handles 246. In this way, the pulling of the handles 246 will result in a controlled movement of both the handles 246 and the slide body 328, so that the two front clips 332 will be released simultaneously or almost simultaneously. The same will account for the two build plate clips 330.

It is noted that the build plate clips 330 could be arranged independently from the front clips 332 without sharing a common clamp element. In some configurations, this may even be preferred because the build plate clips 330 can then be designed independently from the front clips 332. This is preferred if the build plate clips 330 need to be much stronger than the front clips 332. It is noted that the build plate clips 330 need to pull the build plate 220 in the first direction A1 which asks for sufficient frictional forces on the build plate 220.

It is conceivable that only one handle is present which is coupled to a front clip and a build plate clip. It is also conceivable that the handle is spaced apart from the front clips, and that the front clips are coupled on the slide body at a position away from the handle. This also accounts for the embodiments described with reference to FIG. 2-10.

The present invention has been described above with reference to a number of exemplary embodiments as shown in the drawings. Modifications and alternative implementations of some parts or elements are possible and are comprised in the scope of protection as defined in the appended claims. It should be noted that the above-mentioned embodiments illustrate rather than limit the invention, and that those skilled in the art will be able to design many alternative embodiments. In the claims, any reference signs placed between parentheses shall not be construed as limiting the claim. Use of the verb comprise and its conjugations does not exclude the presence of elements or steps other than those stated in a claim. The article ‘a’ or ‘an’ preceding an element does not exclude the presence of a plurality of such elements. The mere fact that certain measures are recited in mutually different dependent claims does not indicate that a combination of these measures cannot be used to advantage.

1. A print bed assembly for an additive manufacturing system, the print bed assembly comprising:
a stage;
a carrier plate coupled to and spaced apart from the stage, the carrier plate extending in a first direction from a rear side of the carrier plate to a front side of the carrier plate, and extending in a second direction which is perpendicular to the first direction;
a build plate removably arranged on the carrier plate;
at least one rear clip arranged to detachably couple the build plate with the carrier plate at the rear side of the carrier plate, wherein the at least one rear clip is arranged to clamp the build plate onto the carrier plate using a first clamping force;
a slide body slidably arranged between the stage and the carrier plate;
at least one front clip arranged to detachably couple the build plate with the carrier plate at the front side of the carrier plate, the at least one front clip being coupled to the slide body, wherein the at least one front clip is arranged to clamp the build plate onto the carrier plate using a second clamping force;
at least one handle coupled to the slide body at the front side of the carrier plate;
at least one push element coupled at a rear side of the slide body, and arranged to move the build plate relative to the carrier plate in the first direction only after the slide body has been moved by a predefined distance,
wherein, upon application of a pulling force on the at least one handle in the first direction, the slide body is moved relative to the carrier plate, wherein first the at least one front clip detaches from the build plate and the carrier plate and then, after the slide body is moved more than the predefined distance, the at least one push element pushes the build plate in the first direction, thereby releasing the build plate out of the at least one rear clip.

2. The print bed assembly according to claim 1, wherein the second clamping force applied by the at least one front clip is less than the first clamping force applied by the at least one rear clip.

3. The print bed assembly according to claim 1, wherein the carrier plate comprises at least one cut-out disposed at the rear side and aligned with the at least one push element, and wherein, after the slide body is moved by at least the predefined distance, the at least one cut-out at least partially receives the at least one push element therein.

4. The print bed assembly according to claim 3, wherein the at least one cut-out has a cut-out length, wherein the at least one push element is arranged to move the build plate by a distance in the first direction, such that the distance is equal to the cut-out length of the at least one cut-out.

5. The print bed assembly according to claim 4, wherein the cut-out length of the at least one cut-out is in a range from 10 mm to 15 mm.

6. The print bed assembly according to claim 1, further comprising a pair of side guides arranged to couple with each of the carrier plate and the build plate.

7. The print bed assembly according to claim 6, wherein each of the pair of side guides extends from the at least one rear clip.

8. The print bed assembly according to claim 1, wherein, upon application of the pulling force, the at least one push element is moved in the first direction from a first position to a second position, wherein, in the first position, the at least one push element is spaced apart from the rear side of the carrier plate by at least the predefined distance, and wherein, in the second position, the at least one push element abuts the build plate.

9. The print bed assembly according to claim 1, wherein the at least one push element is integral with the slide body.

10. The print bed assembly according to claim 1, further comprising at least one flexible member coupling the at least one push element with the slide body.

11. The print bed assembly according to claim 1, further comprising at least one further push element coupled to the at least one handle via the slide body, the at least one further push element being spaced apart from the at least one push element in the second direction, wherein the at least one further push element is arranged to engage the at least one rear clip after the slide body is moved in the first direction by a distance greater than the predefined distance, in order to open the at least one rear clip.

12. The print bed assembly according to claim 1, further comprising at least one guiding member at least partially arranged between the stage and the carrier plate, wherein the slide body is guided by the at least one guiding member during movement of the slide body relative to the carrier plate.

13. The print bed assembly according to claim 12, wherein the slide body comprises at least one slot therethrough, and wherein the at least one guiding member is at least partially and slidably received within the at least one slot of the slide body.

14. The print bed assembly according to claim 1, wherein the at least one rear clip comprises a leaf spring.

15. The print bed assembly according to claim 1, wherein the carrier plate is spaced apart from the slide body by a vertical offset in a third direction perpendicular to the first and second directions, and wherein the vertical offset between the carrier plate and the slide body lies in a range of 1 mm to 4 mm.

16. The print bed assembly according to claim 1, further comprising a heating element arranged under or in the carrier plate.

17. An additive manufacturing system comprising the print bed assembly according to claim 1.
